(19) United States
(12) Patent Application Publication
(10) Pub. No.: US 2008/0177975 A1
(43) Pub. Date: Jul. 24, 2008

(54) DATABASE MANAGEMENT SYSTEM FOR CONTROLLING SETTING OF CACHE PARTITION AREA IN STORAGE SYSTEM

(76) Inventor: Nobuo KAWAMURA, Atsugi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/970,602

(22) Filed: Jan. 8, 2008

(30) Foreign Application Priority Data
Jan. 23, 2007 (JP) 2007-012995

(51) Int. Cl. G06F 12/00

(52) U.S. Cl. 711/173; 711/E12.002

(57) ABSTRACT

A database management system comprises a setting processor and an instruction sending unit. The setting processor determines the size related to each cache partition area associated with each database buffer on the basis of the size related to the each database buffer. The setting processor also produces a partition setting instruction, more specifically an instruction to perform setting related to each of the cache partition areas at the determined size. The instruction sending unit sends the produced partition setting instruction.

### CROSS REFERENCE TO PRIOR APPLICATION

This application relates to and claims the benefit of priority from Japanese Patent Application number 2007-12995, filed on Jan. 23, 2007, the entire disclosure of which is incorporated herein by reference.

### BACKGROUND

The present invention relates to the logical partition of cache memory in a storage system.

A storage system generally comprises a plurality of storage devices, and accesses data in at least one of these storage devices according to an access command (write command or read command) sent from a host computer. This type of storage system usually also comprises a cache memory for temporarily storing this data. Technology related to the management of cache memory has been disclosed, for example, in Japanese Laid-Open Patent Application Nos. 2004-030090, 2004-295790, and 2005-285058, U.S. Pat. No. 5,434,992, and Japanese Laid-Open Patent Application No. 2006-227688.

Among computer systems comprising a storage system and a host computer, there is a system in which, for example, a storage system stores a database, and a system that manages this database (hereinafter abbreviated as DBMS) operates on a host computer. With a computer system such as this, the DBMS preferably has high performance (such as speed) in terms of accessing the database.

One possible way to improve database access performance is to employ a technique in which the cache memory of a storage system (hereinafter referred to as storage cache) is logically partitioned. This technique reduces interference (competition) in accessing the storage cache. This type of technique has been disclosed, for example, in Japanese Laid-Open Patent Application No. 2006-227688 out of the publications listed above. This type of technique will hereinafter be called a “storage cache partitioning technique.” The areas obtained by logical partitioning will be called “cache partition areas.” A cache partition area is made up of a grouping of sub-areas of the same size. These sub-areas will hereinafter be called “segments.” A segment is a data size unit (access unit) for one access of storage cache. With a storage cache partitioning technique, the size of a segment can vary from cache partition area to cache partition area.

Another possible method is to employ a technique in which, for example, a DBMS mainly accesses a database buffer within a host computer, and if necessary, an access command to access the database in a storage system is issued to the storage system. The term database buffer here is a storage area for storing the data to be accessed by the DBMS (data written to the database or data read from the database), and is an area set in the memory of a host computer. This technique allows the number of times an access command is issued to the storage system to be reduced. This technique will hereinafter be called a “database buffer technique.” A DBMS can manage a plurality of logical storage areas (hereinafter referred to as database areas) respectively corresponding to a plurality of objects such as tables or indexes (database objects). With a database buffer technique, a plurality of database buffers can be set corresponding to the plurality of database areas. A database buffer is made up of a grouping of sub-areas of the same size. These sub-areas will hereinafter be called “pages.” A page is a data size unit (access unit) for one access of a database buffer. With a database buffer technique, the size of a page can vary from database buffer to database buffer.

To improve the database access performance as much as possible, it is believed to be preferable to employ both a storage cache partitioning technique and a database buffer technique, rather than just one or the other. This is because a database buffer technique allows the number of times an access command is issued to the storage system to be reduced, and even when an access command is issued to the storage system, interference with access to the storage cache can be reduced.

However, if these two techniques are merely used together, it seems that there will be a problem with how efficiently the storage cache is utilized. This is because with a storage cache partitioning technique, the size of the segments can be varied for each storage cache partition area, while with a database buffer technique, the size of the pages can be varied for each database buffer, and the segments and pages are independent from each other.

### SUMMARY

It is therefore an object of the present invention to minimize the decrease in storage cache utilization efficiency in a computer system that employs both a storage cache partitioning technique and a database buffer technique.

A database management system comprises a setting processor and an instruction sending unit. The setting processor determines the segment size of each of the cache partition areas associated with database buffers, on the basis of the size related to these database buffers. Also, the setting processor produces a partition setting instruction, and more specifically an instruction to perform setting related to each of the cache partition areas at the determined size. The instruction sending unit sends the partition setting instruction thus produced. As long as the partition setting instruction can eventually be received by the storage system, the partition setting instruction may be sent directly to the storage system, or it may be sent to the storage system via another computer such as a managing computer.

The various components discussed above can also be in the form of hardware (such as a circuit), a computer program, or a combination of these (such as one or a plurality of CPUs that read and execute computer programs). The computer programs can be read from storage resources (such as memory) with which the computer machines are equipped. These storage resources can be installed via a recording medium such as a CD-ROM or DVD (Digital Versatile Disk), or can be downloaded via a communications network such as the Internet or a LAN.

### BRIEF DESCRIPTION OF THE DRAWINGS

FIG. 1 shows the overall configuration of the system pertaining to a first embodiment of the present invention;

FIG. 2 is a diagram of the functions of a host computer 11, a storage system 31, and a managing computer 41;

FIG. 3 shows the corresponding relationship between the physical and logical structures of a cache partition area;

FIG. 4 shows the corresponding relationship between a segment and a parent sub-segment management block and child sub-segment management block;

FIG. 5A shows a first GUI displaying a storage manager 141;

FIG. 5B shows a second GUI displaying the storage manager 141 when a specific operation is performed on the first GUI;

FIG. 6 shows an example of the configuration of a database access environment;

FIG. 7A shows an example of a database area definition;

FIG. 7B shows an example of a database buffer definition;

FIG. 8A shows an example of the configuration of a database buffer disk mapping table 401;

FIG. 8B shows an example of a storage cache control instruction table 403;

FIG. 9 shows an example of the configuration of a storage cache disk mapping table;

FIG. 10 shows an example of the flow in database buffer construction processing executed by a DBMS 17 in a database initial setting phase;

FIG. 11 shows an example of the flow of the processing executed in a storage system 31 that has received a cache group initial allocation instruction;

FIG. 12 shows an example of the flow of partition setting;

FIG. 13 shows an example of a buffer hit management table 501 during initial setting, and an example of the buffer hit management table 501 at a time T;

FIG. 14 shows an example of the flow of the processing executed by the DBMS 17 in a system operation phase;

FIG. 15 shows an example of the flow of the processing performed in the storage system 31 that has received a partition change instruction;

FIG. 16A shows a first example of the logical partitioning of a storage cache 311;

FIG. 16B shows a second example of the logical partitioning of the storage cache 311;

FIG. 17 shows an example of the flow of the processing executed in the storage system 31 that has received a cache group initial allocation instruction in a second embodiment;

FIG. 18 shows an example of the flow of the processing executed by the DBMS 17 in a system operation phase of a third embodiment;

FIG. 19 shows an example of the storage cache control instruction table 403 before and after partition size has been changed;

FIG. 20A shows an example of the database buffer disk mapping table 401 in a fourth embodiment of the present invention;

FIG. 20B shows an example of the storage cache control instruction table 403 in the fourth embodiment; and

FIG. 20C shows an example of the database buffer definition in the fourth embodiment.

### DESCRIPTION OF THE PREFERRED EMBODIMENTS

The concept behind an embodiment of the present invention will now be described.

A database management system (DBMS) comprises a database setting processor and a storage cache adjustment processor. The database setting processor can determine the size related to each cache partition area associated with each database on the basis of the size related to each database buffer. Also, the database setting processor produces a partition setting instruction, and more specifically an instruction to perform setting related to each of the cache partition areas at the determined size. The database setting processor can send the produced partition setting instruction by calling the storage cache adjustment processor.

The size related to each database buffer can be the size of a page for each of these database buffers, or can be the buffer size, which is the size of the database buffer itself. The size related to each cache partition area can be the size of a segment for each of these cache partition areas, or can be the partition size, which is the size of the cache partition area itself.

The database setting processor can be such that the segment size of each of the cache partition areas is the same as the page size of each database buffer associated with each cache partition area. Also, in the database initial setting phase (discussed below), the partition size of each of the cache partition areas can be the same as the buffer size of each database buffer associated to each cache partition area.

A plurality of database buffers are respectively associated with a plurality of database areas managed by the DBMS. Also, a plurality of storage devices within a storage system are respectively associated with a plurality of database areas. The term storage device as used here may be a logical storage device (such as the logical unit discussed below), or may be a physical storage device (such as the disk devices discussed below).

The DBMS further comprises an access controller for executing access to each database area. When the access controller executes access to a certain database area, if there is a buffer hit in a corresponding database buffer, which is a database buffer corresponding to this certain database area, the area reserved by the buffer hit can be accessed. If there is no buffer hit, an access command designating a storage device allocated to a cache partition area associated with the corresponding database buffer is sent from the host computer to the storage system. In this case, the storage system can temporarily hold data according to this access command in an area reserved by cache hit in the cache partition area to which the storage device designated by the access command has been allocated.

The above-mentioned access controller can calculate for each database buffer a buffer hit ratio indicating the number of buffer hits out of the number of times the database buffer has been accessed. The database setting processor can produce an instruction signifying a setting change of the size related to at least one of the plurality of cache partition areas, as the partition setting instruction, on the basis of the buffer hit ratio for each database buffer. More specifically, for example, the database setting processor can produce an instruction including a delete meaning, which means to delete from the cache memory all or part of the cache partition area associated with a database buffer whose buffer hit ratio is at or above a specific threshold. Also, the database setting processor can produce an instruction including an add meaning, which means to add an area equivalent to the size of the deleted area to another cache partition area out of the plurality of cache partition areas. The delete meaning and add meaning may be included in a single partition setting instruction, or may be divided among a plurality of partition setting instructions.

As long as the intended meaning is executed, at least one of the meaning of the setting change and the delete meaning and add meaning (which are specific examples of the former meaning) may be in any form. For instance, which cache partition area to delete, or what size the cache partition area will be after being changed, may be included in a partition setting instruction.

A number of specific embodiments will now be described.

### First Embodiment

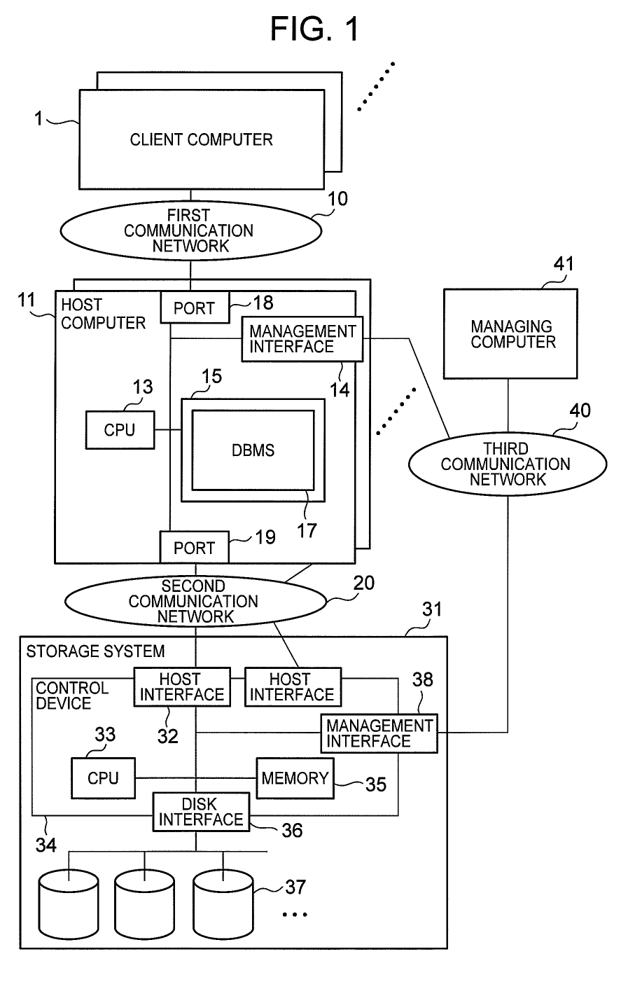

FIG. 1 shows the overall configuration of the system pertaining to a first embodiment of the present invention.

A host computer 11 is connected to a client computer 1 via a first communication network 10 (such as a LAN (Local-Area Network)), is connected to a storage system 31 via a second communication network 20 (such as a SAN (Storage Area Network), and is connected to a managing computer 41 via a third communication network 40 (such as a LAN). The managing computer 41 is a computer that manages both the host computer 11 and the storage system 31.

The storage system 31 comprises a plurality of disk devices 37 (may be hard disk drives (HDD), flash memory, or another type of physical storage device) and a control device 34 that controls access to the disk devices 37. The control device 34 comprises, for example, an interface device 32 (such as a communication port; hereinafter “host interface”) that communicates with the host computer 11 via the second communication network 20, an interface device 38 (such as a communication port; hereinafter “management interface”) that communicates with the managing computer 41 via the third communication network 40, an interface device 36 (such as a communication port; hereinafter “disk interface”) that communicates with the disk devices 37, a CPU 33, and a memory 35. The memory 35 includes a cache memory, which is the storage cache discussed below. This cache memory can be one or a plurality of memories, or can be logical storage areas provided to these.

The host computer 11 can be equipped with the CPU 13, or a storage resource 15, or an interface device 18 (such as a communication port) connected to the first communication network 10, or an interface device 19 (such as a communication port) connected to the second communication network 20, or an interface device 14 (such as a communication port) connected to the third communication network 40. The storage resource 15 is, for example, a memory or an auxiliary storage device (such as a HDD), or a combination of these. The storage resource 15 can store a database management system (hereinafter abbreviated as DBMS) 17 as a computer program. The CPU 13 can read and execute the DBMS 17. The DBMS 17 analyzes requests from the client computer 1 (such as SQL (Structured Query Language) text), and executes processing based on the result of this analysis. In order to facilitate description, the subject of processing performed by the CPU by reading and executing a computer program will sometimes be the computer program, rather than the CPU.

In the above constitution, the first communication network 10, the second communication network 20, and the third communication network 40 may be such that at least two of them are integrated, or at least one of them may be a mainframe network. Also, at least one of the client computer 1, the host computer 11, and the storage system 31 may be the virtual product of a single device (such as what is called a virtual computer). Also, the above-mentioned constitution of the control device 34 is just one example, and other constitutions may be employed instead.

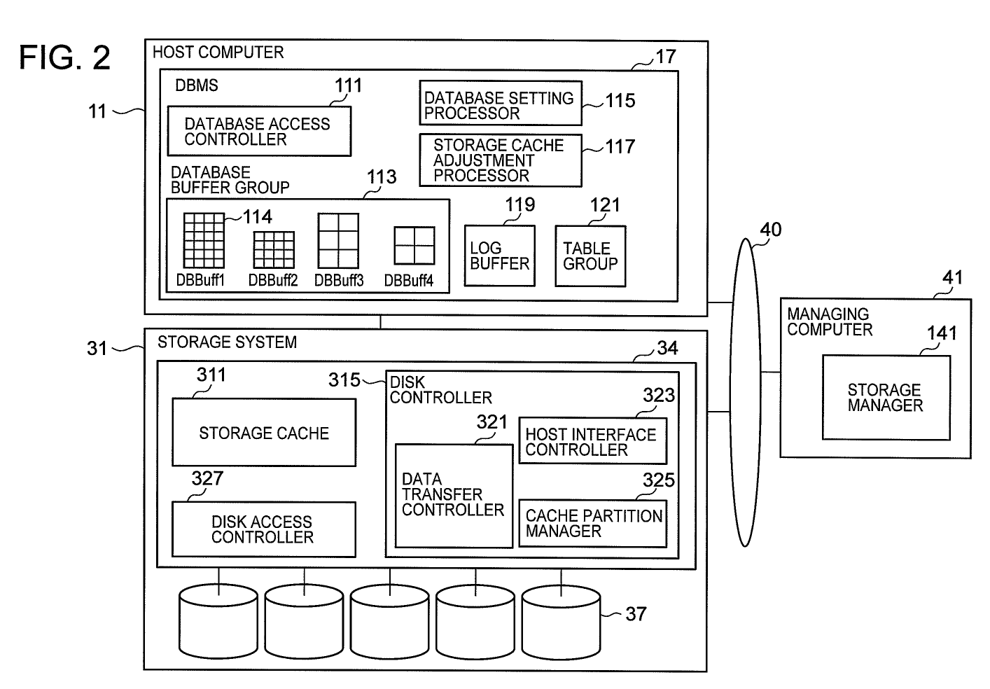

FIG. 2 is a diagram of the functions of the host computer 11, the storage system 31, and the managing computer 41.

A storage manager 141 is a computer program executed by the CPU of the managing computer 41. The storage manager 141 receives an instruction from the DBMS 17, and if this instruction is a specific type of instruction, it is sent to the control device 34.

The DBMS 17 features a database buffer technique, while the storage system 31 features a storage cache partitioning technique.

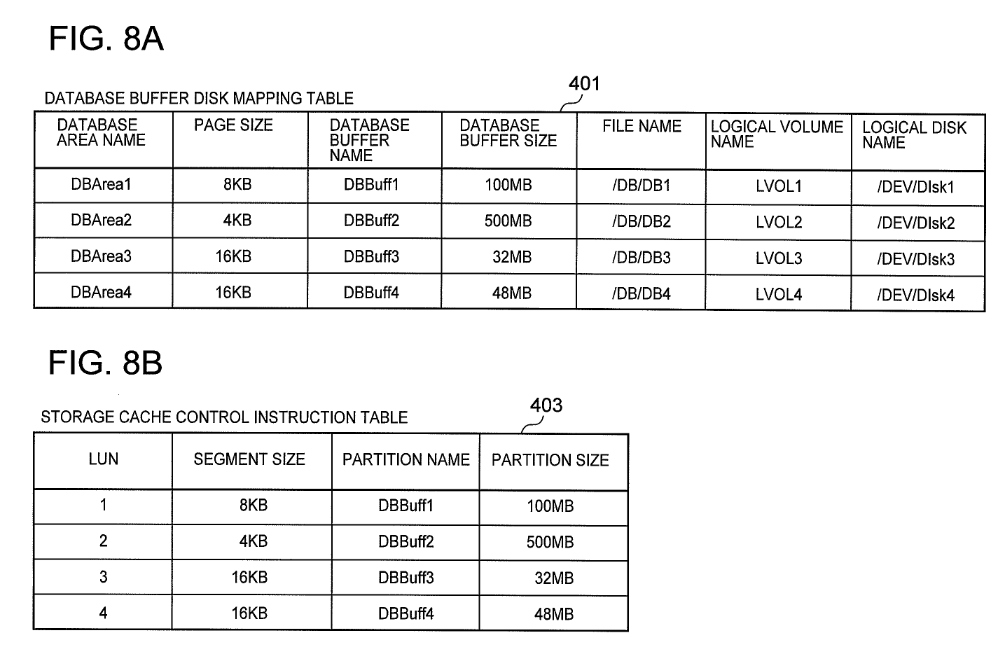

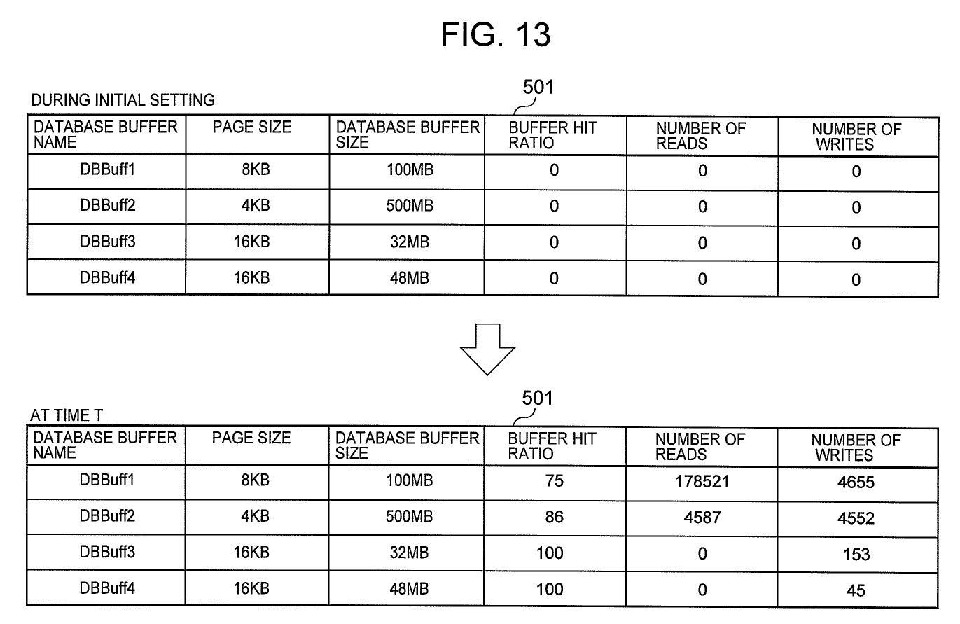

The DBMS 17 has a database access controller 111, a database setting processor 115, and a storage cache adjustment processor 117. A database buffer group 113 made up of one or more database buffers 114 is prepared in the storage resource 15 (such as a memory) of a host computer 11A. A log buffer 119 is prepared, and a table group 121 is stored, in this storage resource 15 (such as a memory). The tables included in this table group 121 are not tables whose object is databases (that is, tables for managing databases), but rather a buffer hit management table 501 (discussed below) for managing the buffer hit ratio in the database buffers 114 (see FIGS. 13A and 13B), or a database buffer disk mapping table 401 (discussed below) for managing the mapping of database buffers and logical disks (see FIG. 8A).

The database access controller 111 executes processing to access databases (such as data update or reference), and produces a log of this access processing and stores it in a log buffer 119 (a buffer for storing a log). Since a database buffer technique is employed with this DBMS 17, the database access controller 111 accesses the database buffers 114 in the database buffer group 113, and if necessary, accesses the storage system 31.

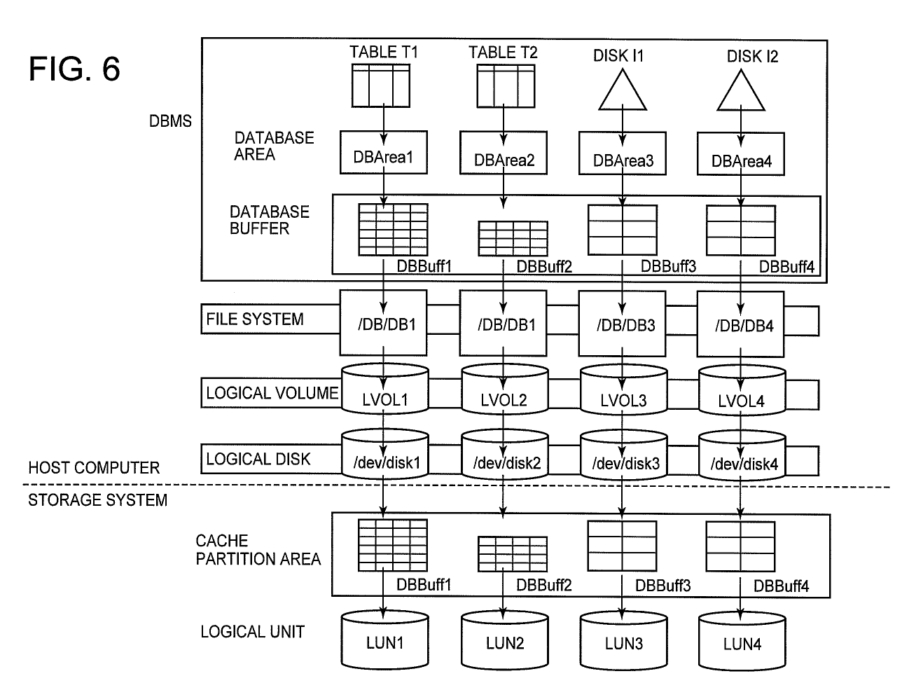

The database setting processor 115 constructs a database access environment in the database initial setting phase. The phrase “database access environment” as used in this embodiment means an environment made up of a plurality of physical or logical environment elements necessary for the DBMS 17 to access the databases in the storage system 31. “Constructs a database access environment” means associating two or more environment elements out of the plurality of environment elements (a specific example of a constructed database access environment will be described later through reference to FIG. 6). The “database initial setting phase” is a phase in which the various initial settings necessary for operating the system pertaining to this embodiment (in other words, the various initial settings necessary for allowing the DBMS 17 to access the databases) are performed by the host computer 11 or the storage system 31. Specifically, in this embodiment, there are at least two phases: a database initial setting phase and a system operation phase. The system operation phase is entered upon completion of the required initial settings in the database initial setting phase. The system operation phase may include various types of operation phase, such as a test operation phase, which is a phase for operating the system on a trial basis, determining whether or not the initial settings are appropriate, and tuning the initial settings as needed, and a real operation phase, which is a phase for operating the system on a real basis for purposes such as carrying out a specific task.

The storage cache adjustment processor 117 performs processing related to adjustment of a storage cache 311. More specifically, for example, the storage cache adjustment processor 117 sends the storage system 31 an instruction to execute a setting related to the logical structure of the storage cache 311 (hereinafter referred to as a storage cache setting instruction, an example of which is the cache group initial allocation instruction discussed below, or the partition change instruction discussed below). This storage cache setting instruction is received by a host interface controller 323 (discussed below) and analyzed and processed by a cache partition manager 325 in the storage system 31. Specifically, in this embodiment, the DBMS 17 is equipped with the storage cache adjustment processor 117 as an interface for having the storage system 31 execute a setting related to the logical structure of the storage cache 311, while the storage system 31 is equipped with the host interface controller 323 as an interface for receiving storage cache setting instructions from this former interface.

As discussed above, the control device 34 of the storage system 31 is equipped with the storage cache 311. Examples of computer programs executed by the CPU 33 of this control device 34 (such as computer programs stored in the memory 35) include a disk access controller 327 that controls access to the disk devices 37, and a disk controller 315 that performs processing of access commands from the DBMS 17, setting related to the logical structure of the storage cache 311, and so forth. The disk controller 315 has a host interface controller 323, a data transfer controller 321, and a cache partition manager 325.

The host interface controller 323 is a computer program that functions as an interface to the host computer 11. The host interface controller 323 receives commands from the host computer 11, and when a command has been received, it determines the type of command received, and transfers this received command to another unit 321 or 325 that can process this command, according to the type of command determined. More specifically, for example, if the received command is an access command, the host interface controller 323 transfers this access command to the data transfer controller 321, but if the received command is a storage cache setting instruction, it is transferred to the cache partition manager 325.

The data transfer controller 321 is a computer program that executes access command processing. The data transfer controller 321 receives an access command from the host interface controller 323, analyzes this access command, and causes the disk access controller 327 to execute access according to the access command.

The cache partition manager 325 is a computer program that manages cache partition areas. The cache partition manager 325 receives a storage cache setting instruction from the host interface controller 323, analyzes the instruction, and executes setting related to the cache partition areas according to this instruction.

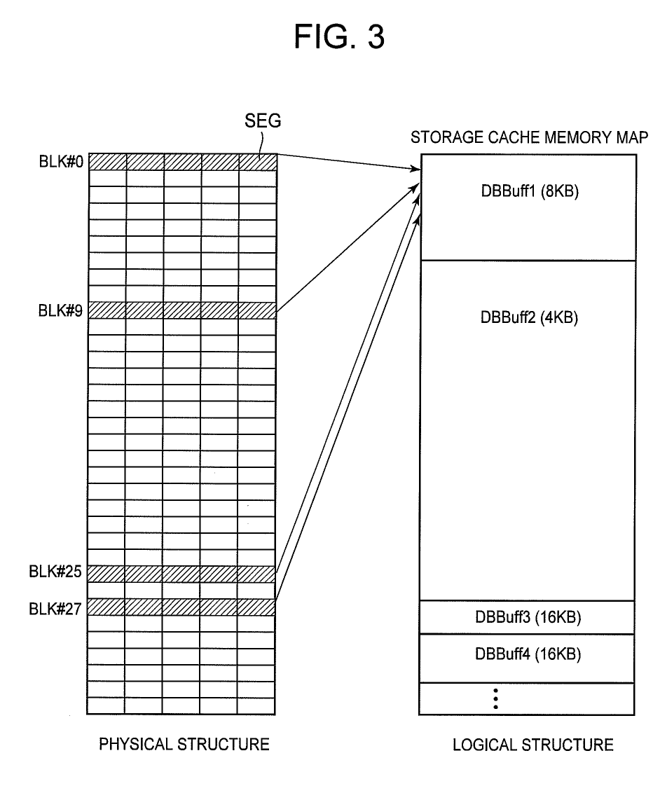

FIG. 3 shows the corresponding relationship between the physical and logical structures of a cache partition area.

The storage cache 311 can be logically partitioned into a plurality of cache partition areas by allocating one or more blocks of the storage cache 311 to various cache partition areas. The term block as used here refers to an area made up of a plurality of continuous segments. The plurality of blocks allocated to a single cache partition area need not be a continuous area in the storage cache 311, and may be located apart from each other. As an example of this, in FIG. 3, the plurality of blocks BLK#0, BLK#9, BLK#25, and BLK#27, which are located apart from each other, are shown as mapping to a single cache partition area called DBBuff1.

Thus performing the logical partitioning of the storage cache 311 by block mapping allows changes of the size of a cache partition area to correspond to block mapping changes.

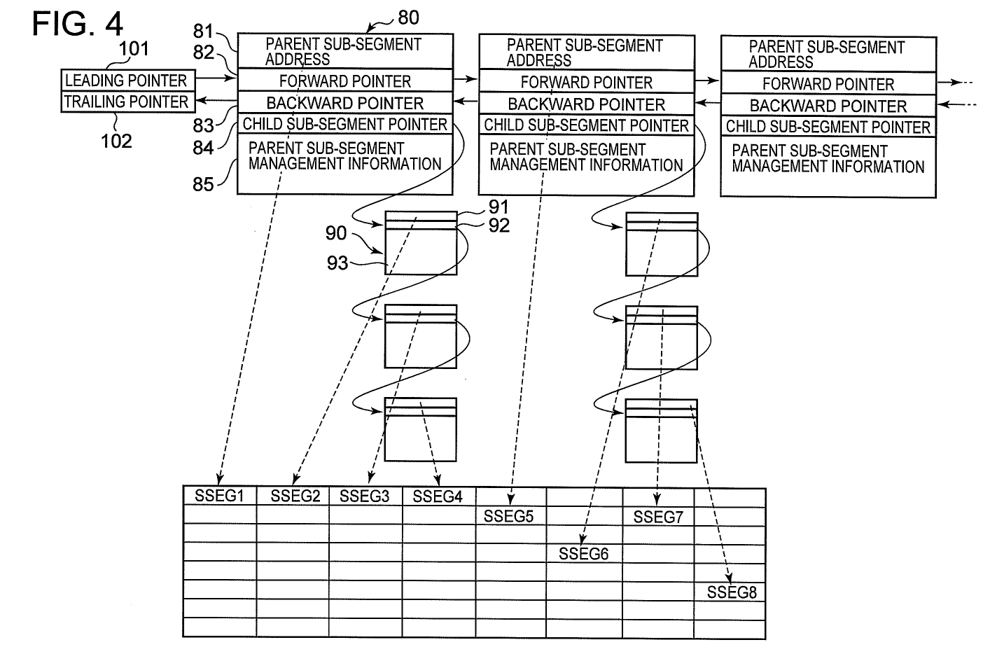

FIG. 4 shows the corresponding relationship between a segment and a parent sub-segment management block and child sub-segment management block.

In this embodiment, a segment is made up of one or a plurality of sub-segments, and the size of a segment is adjusted by adjusting the number of sub-segments that make up a segment. The size of a sub-segment is set ahead of time to a fixed size, for example. When a segment is made up of a plurality of sub-segment, the first sub-segment that is accessed in that segment is called a “parent sub-segment,” and the second and subsequent sub-segments that are accessed are called “child sub-segment.” When no distinction is made between parent sub-segments and child sub-segments, the term is merely “sub-segment.” Specifically, in this embodiment, a sub-segment is a physical management unit of the storage cache 311, and a segment is a data size unit (that is, an input/output unit) in a single access to the storage cache 311.

In FIG. 4, SSEG1 to SSEG8 indicate the accessed sub-segments in the order of their access. When the size of the sub-segments is set to the default of 16 KB, four sub-segments must be grouped into a segment to achieve a segment size of 64 KB. For example, if we let SSEG1 be the parent sub-segment, and the three subsequent sub-segments SSEG2 to SSEG4 be child sub-segments, and logically associate them with each other, the result is a single segment. Similarly, if we let SSEG5 be a parent sub-segment, and the three subsequent sub-segments SSEG6 to SSEG8 be child sub-segments, and logically associate them with each other, the result is a single segment.

The parent sub-segments and child sub-segments do not necessarily have to be disposed in a continuous storage area, and may be separated from each other in the cache memory.

A parent sub-segment management block 80 includes a parent sub-segment address 81, a forward pointer 82, a backward pointer 83, a child sub-segment pointer 84, and parent sub-segment management information 85. The parent sub-segment address 81 indicates the location of the parent sub-segment managed by the parent sub-segment management block 80. The forward pointer 82 indicates the parent sub-segment management blocks 80 in the order of the one accessed earliest. The backward pointer 83 indicates the parent sub-segment management blocks 80 in the order of the one accessed most recently. The child sub-segment pointer 84 indicates a child sub-segment management block 90. The parent sub-segment management information 85 includes the status (dirty, clean, or free) of a parent sub-segment and so forth. When dirty data is mixed with clean data in a parent sub-segment, the status thereof is managed by means of bitmap information. Incidentally, “dirty data” means data that has not yet been stored in the disk devices 37, and “clean data” means data that has been stored in the disk devices 37 (means that the same data is in the disk devices 37).

The child sub-segment management block 90 includes a child sub-segment address 91, a forward pointer 92, and child sub-segment block information 93. The child sub-segment address 91 indicates the location of a child sub-segment managed by the child sub-segment management block 90. The forward pointer 92 indicates the child sub-segment management blocks 90 in the order of the one accessed earliest. The child sub-segment block information 93 includes the status of a child sub-segment and so forth. When dirty data is mixed with clean data in a child sub-segment, the status thereof is managed by means of bitmap information.

A leading pointer 101 indicates the tail end of a forward pointer 82, and a trailing pointer 102 is indicated by the leading backward pointer 83.

Thus, the queue-managed the parent sub-segment management block 80 and child sub-segment management block 90 are managed as a dirty queue if the status is dirty data, and are managed as a clean queue if the status is clean data. The result of constituting a segment by logically associating a parent sub-segment with a plurality of child sub-segments is that if there is a change in the state of the parent sub-segment, the state of the child sub-segments will also change, so destaging processing can be faster.

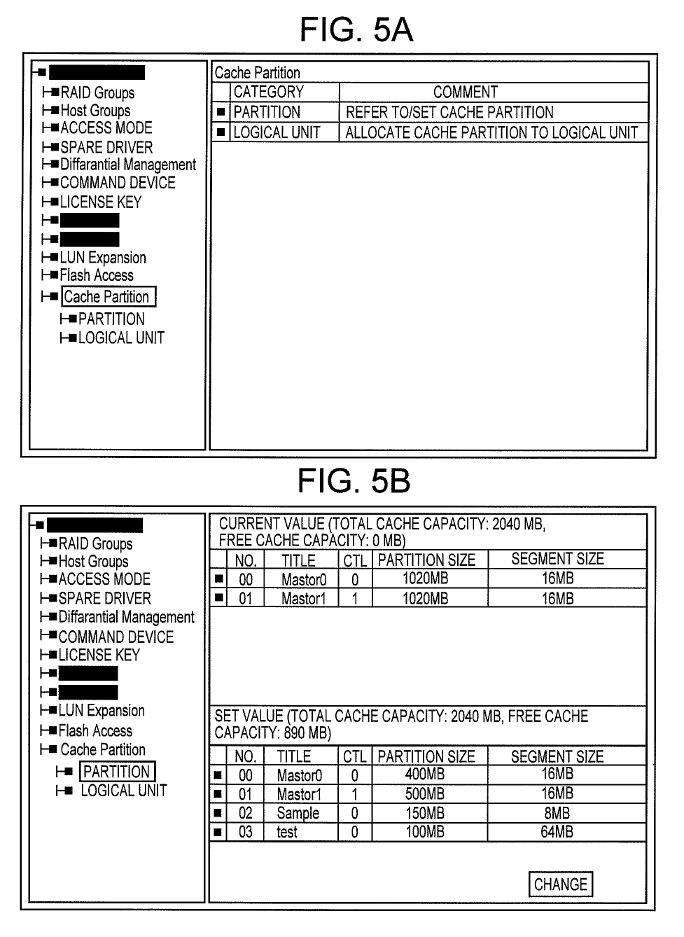

Incidentally, a setting change of the size of a cache partition area, or to the size of the segments of a cache partition area, can be performed, for example, by the human operation of the storage manager 141 of the managing computer 41, so that the GUI (Graphical User Interface) shown in FIG. 5A is displayed, and by having the human manager designate the character string “partition” on this GUI so that the GUI shown in FIG. 5B is displayed, and manipulating this GUI.

FIG. 6 shows an example of the configuration of a database access environment.

This drawing shows four database access environment examples, namely, a first database access environment for accessing the data in a database object called Table T1, a second database access environment for accessing the data in a database object called Table T2, a third database access environment for accessing the data in a database object called Index I1, and a fourth database access environment for accessing the data in an index object called Index I2. All of these database access environments are constituted such that a single database area is associated with a single database object, a single database buffer 114 is associated with this one database area, a single file is associated with this one database buffer 114, a single logical volume is associated with this one file, a single logical disk is associated with this one logical volume, a single cache partition area is associated with this one logical disk, and a single logical unit (LU) is associated with this one cache partition area.

Incidentally, in the database access environments shown in the drawing, everything from the database object to the logical disk is managed within the host computer 11, and the cache partition area and LU are managed within the storage system 31. The operating system (OS) of the host computer 11 includes a plurality of computer programs (not shown), such as a device manager, a volume manager, and a file system. A logical disk is a logical disk device produced by a device manager on the basis of a LU provided by the storage system 31. A logical volume is a logical storage resource produced by a volume manager on the basis of a logical disk. A file is a resource managed by a file system. A database area is a logical storage area managed by the DBMS 17. Also, in the database access environments shown in the drawing, the character strings (such as DBAreal) in the graphics representing database areas are database area names, the character strings (such as DBBuff1) in the vicinity of graphics representing database buffers are database buffer names, the character strings (such as /DB/DB1) in the graphics representing files are file names, the character strings (such as LVOL1) in the graphics representing logical volumes are logical volume names, and the character strings (such as /dev/dsik1) in the graphics representing logical disks are logical disk names. Also, the character strings (such as DBBuff1) in the vicinity of the graphics representing cache partition areas are the names of cache partition areas (partition names), and the numerals in the character strings (such as LUN1) in the graphics representing logical units are logical unit numbers (LUN).

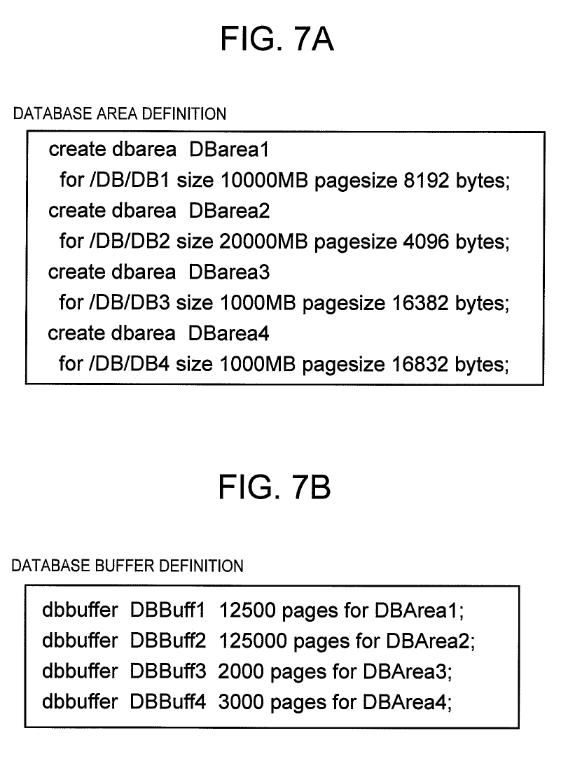

The above-mentioned database access environments are constructed in the database initial setting phase. In the database initial setting phase, for example, the DBMS 17 receives from the client computer 1 the database buffer definition shown in FIG. 7A and the database buffer definition shown in FIG. 7B. The database area definition and/or the database buffer definition is produced by the user of the client computer 1, for example. Information related to a database buffer is recorded in the database area definition for each database area produced, and examples of this information include the database area name, the name of the file associated with that database area, the size of that database area, and the size of a page of the database buffer associated with that database area. Meanwhile, information related to a database buffer is recorded in the database buffer definition for each database buffer, and examples of this information include the database buffer name, the size of the database buffer (designated by the number of pages in the example shown in the drawing), and the name of the database area to be associated. The database setting processor 115 analyzes the database area definition and the database buffer definition, and produces the database buffer disk mapping table 401 shown in FIG. 8A, for example, as information indicating the constitution of each database access environment. This table 401 shows the corresponding relationships between database area, database buffer, file, logical volume, and logical disk. Since the page size and database buffer size are also recorded in this table 401, it can be ascertained which database buffer is of which size, and what size the pages are in this database buffer. The association of the files, logical volumes, and logical disks to the database buffers is executed by the OS by having the database setting processor 115 call a specific computer program of the OS, for example, and the above-mentioned table 401 can be produced by communication with the OS.

With a database access environment constructed as above, access to a database is accomplished by the following process, for example. A case in which a table T1 is updated will be used as an example in this description. In this embodiment, and in the following description, the term “buffer hit” in the case of writing means that a page could be reserved for writing data, and in the case of reading means that a page in which the data to be read was stored could be found. Similarly, the phrase “cache hit” in the case of writing means that a segment could be reserved for writing data, and in the case of reading means that a segment in which the data to be read was stored could be found. The higher the buffer hit ratio, the fewer times an access command is issued to the storage system 31. The higher the cache hit ratio, the better the access performance can be expected to be in the storage system 31.

The database access controller 111 executes writing to a database area DBArea1 corresponding to the table T1. More specifically, the database access controller 111 writes data to one or more pages with buffer hits (pages in the database buffer BBuff1) when there is a buffer hit in the database buffer BBuff1 corresponding to the database area DBArea1, and the updating of the table T1 is ended without issuing a write command to the logical unit LU#1 of the storage system 31. If there has not been a buffer hit, however, the database access controller 111 executes writing to the file /DB/DB1. As a result, a write command designating the LUN 1 is sent from the host computer 11 to the storage system 31 on the basis of the association of the file /DB/DB1, the logical volume LVOL1, the logical disk /dev/disk1, and the LUN 1 (this association is managed by OS, for example). With the storage system 31, since because the LUN 1 has been designated by this write command, the data transfer controller 321 writes data according to the write command to a buffer-hit segment in the cache partition area DBBuff1 corresponding to the LUN 1. The data transfer controller 321 reads this data from the cache partition area DBBuff1, and calls the disk access controller 327 to write the data that has been read to the logical unit with a LUN of 1. As a result, this data is written by the disk access controller 327 to the disk device 37 corresponding to that logical unit.

In this embodiment, the above configuration is used as the configuration of the database access environment in order to make the description easier to understand, but the configuration is not limited to the above, and various other configurations can be employed as dictated by the operating mode. For instance, a single logical volume may be associated with a plurality of files, or a plurality of logical disks may be associated with a single logical volume. Also, for example, the storage system 31 may function as an NAS (Network Attached Storage), in which case the file system shown in the drawings becomes an image in both the host computer 11 and the storage system 31.

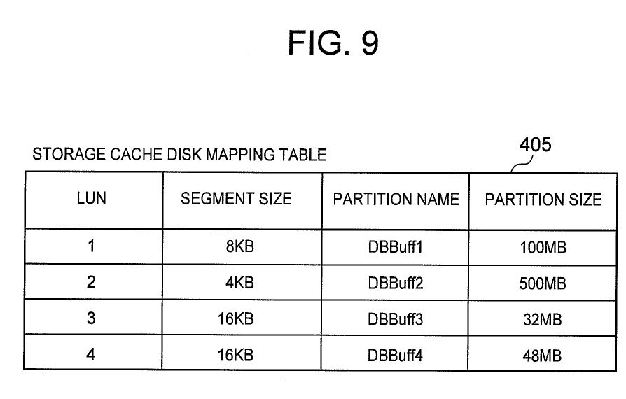

In FIG. 6, each square within a graphic representing a database buffer stands for a page, and each square within a graphic representing a cache partition stands for a segment. Regardless of the configuration of a database access environment, one of the important points in the this drawing is that the database buffer size and page size of a database buffer in the database initial setting phase match the partition size and segment size of the cache partition area corresponding to that database buffer. The partition size and segment size are designated by a storage cache setting instruction from the DBMS 17. More specifically, in the database initial setting phase, for example, the storage cache control instruction table 403 shown in FIG. 8B is produced by the database setting processor 115. In the storage cache control instruction table 403 are recorded, for each cache partition area associated with each database buffer, the LUN of the logical unit associated with that cache partition area, and the segment size, partition name, and partition size of that cache partition area (the size of the cache partition area itself). The segment size and partition size are set to values that are the same as the page size and database buffer size of the corresponding database buffer. When this storage cache control instruction table 403 is sent to the storage system 31, the storage cache disk mapping table 405 shown in FIG. 9 is produced by the cache partition manager 325 and stored in the memory 35. In the storage cache disk mapping table 405 are recorded, for example, which cache partition areas are associated with which logical units, and what the partition size and segment size are of those cache partition areas. The cache partition areas are managed within the storage system 31 by the method described through reference to FIGS. 3 and 4, for example.

The process flow in this embodiment will now be described. This description will be divided into the database initial setting phase and the system operation phase. Also, in the following description, the storage cache setting instruction is sent from the DBMS 17 to the storage system 31 without going through the storage manager 141 of the managing computer 41, but the storage cache setting instruction may be sent from the DBMS 17 to the storage manager 141, and from the storage manager 141 to the storage system 31.

### Database Initial Setting Phase

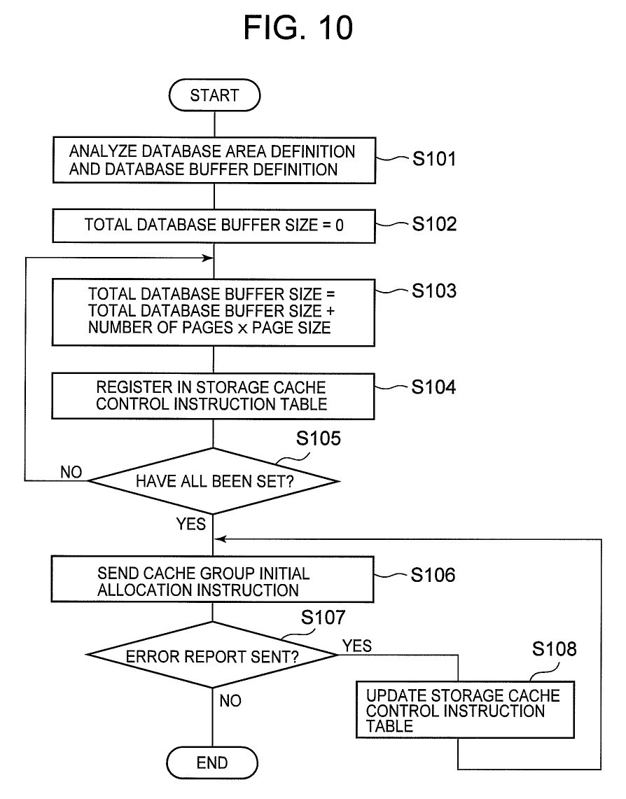

FIG. 10 shows an example of the flow in database buffer construction processing executed by a DBMS 17 in a database initial setting phase. In the drawing, the letter S stands for step.

In step 101, the database setting processor 115 analyzes the database area definition (see FIG. 7A) and database buffer definition (see FIG. 7B) from the client computer 1. This specifies the number of pages and the page size of the database buffers to be prepared, for example.

In step 102, the database setting processor 115 sets the overall database buffer size to an initial value of zero (0).

In step 103, the database setting processor 115 calculates the database buffer size by multiplying the number of pages by the page size for a certain database buffer specified by the analysis of the database area definition and database buffer definition, and adds the calculated database buffer size to the above-mentioned overall database buffer size.

In step 104, the database setting processor 115 registers in the storage cache control instruction table 403 information related to the cache partition area corresponding to this certain database buffer. More specifically, a partition name that is the same as the database buffer name of this certain database buffer, a segment size that is the same as the page size of this certain database buffer, a partition size that is the same as the database buffer size of this certain database buffer, and the LUN corresponding to the logical disk corresponding to this certain database buffer (such as a LUN acquired from an OS) are registered. At the stage of this step 104, information related to this certain database buffer may be registered in a certain column of the database buffer disk mapping table 401.

In step 105, the database setting processor 115 determines whether or not steps 103 and 104 were executed for all of the cache partition areas corresponding to all of the database buffers specified by analysis of the database area definition and the database buffer de. If these steps have been executed, the flow performs to step 106, but if they have not been executed, step 103 is executed for any unprocessed database buffers. The overall database buffer size to which a database buffer size has been added in this step 103 is the overall database buffer size after updating in the previous step 103.

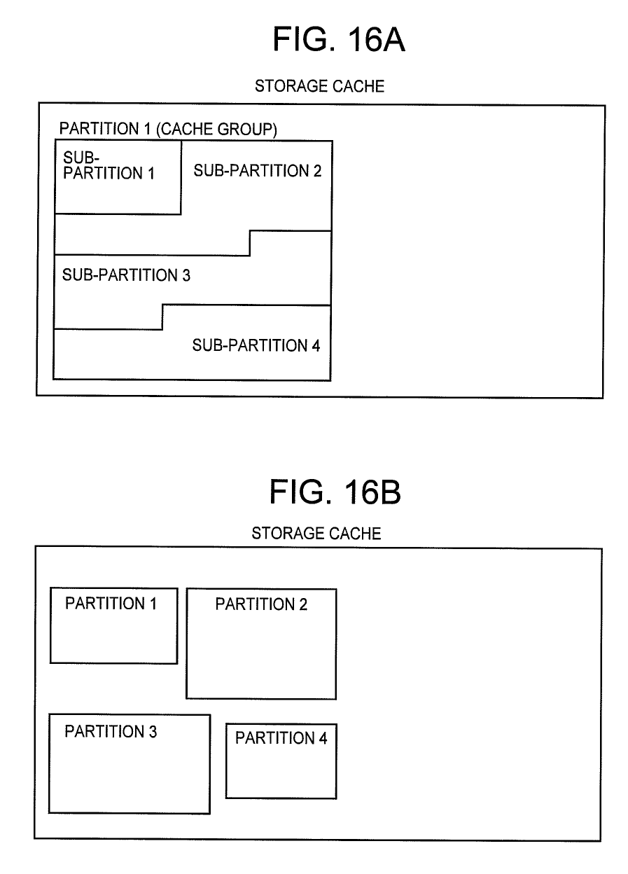

In step 106, the database setting processor 115 prepares a cache group initial allocation instruction and calls the storage cache adjustment processor 117, the result being that the cache group initial allocation instruction is sent by the storage cache adjustment processor 117 to the storage system 31. The storage cache control instruction table 403 produced above is also sent at this time. In this embodiment, the term “cache group” refers to a grouping of one or more cache partition areas corresponding to a single DBMS 17. Specifically, in this embodiment, as shown in the example of FIG. 16A, one partition area (cache group) is prepared for a single DBMS 17, and this one partition area forms a plurality of sub-partition areas (cache partition areas) corresponding to the plurality of database buffers managed by this one DBMS 17. However, a configuration devoid of the concept of a cache group is also possible, such as one in which cache partition areas are merely formed for each database buffer as shown in FIG. 16B.

In step 107, if the storage cache adjustment processor 117 has received an error report, the answer is YES in step 107, the database setting processor 115 is notified that an error report has been received, the flow proceeds to step 108, and the flow ends when a completion report is received.

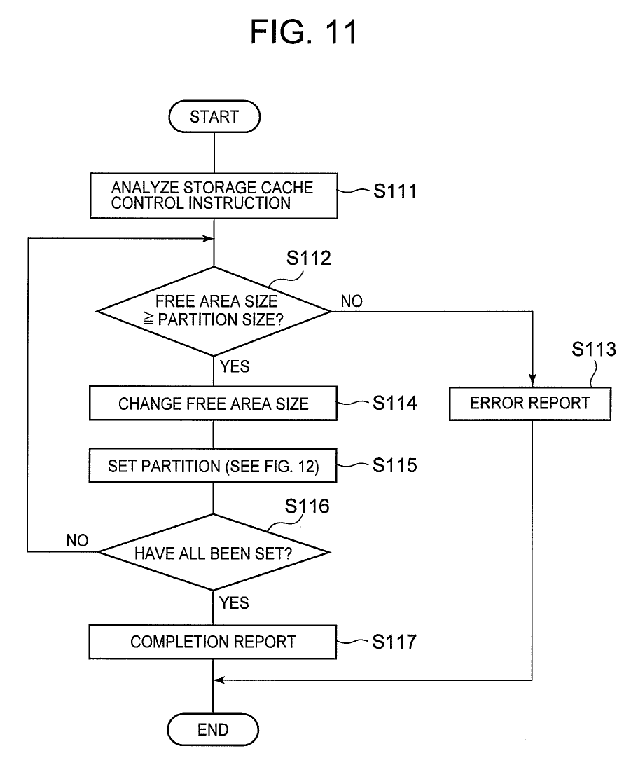

In step 108, the database setting processor 115 executes storage cache control instruction table update processing. Specifically, the storage cache control instruction table received in step 106 is updated. The reason for the receipt of an error report is that, as can be understood by the description below with reference to FIG. 11, the storage cache 311 does not include free area equal to or greater than the total size of the one or more partitions recorded in the storage cache control instruction table 403, so possible methods for updating this table 403 include the following methods 1 to 3. In the following methods, if the number of size of cache partition areas is changed, then the number or size of the corresponding database buffers may also be changed. This is because buffer size and partition size correspond to each other, and page size and segment size also correspond to each other. The method is not limited to the following methods 1 to 3, and other methods may be used instead.

### Method 1

The database setting processor 115 multiplies a certain reduction ratio by the size of each database buffer and the size of each partition. This reduction ratio may be determined ahead of time, or, if the error report includes how much the free area is lacking (that is, the insufficient free area size), then the reduction ratio may be determined by the database setting processor 115 on the basis of the insufficient free area size.

### Method 2

The database setting processor 115 consolidates cache partition areas with the same segment size into a single [area], and multiplies a certain reduction ratio by the partition size of the consolidated cache partition areas. This reduces the number of partitions and the partition size.

### Method 3

The database setting processor 115 halts the execution of logical partitioning of the storage cache 311.

FIG. 11 shows an example of the flow of the processing executed in the storage system 31 that has received a cache group initial allocation instruction.

In step 111, the cache partition manager 325 receives the storage cache control instruction table 403 along with a cache group initial allocation instruction, and analyzes this table 403.

In step 112, the cache partition manager 325 determines whether or not the current free area size (the size of the free area in the storage cache 311) is greater than or equal to a certain partition out of the storage cache control instruction table 403. If the current free area size is less than this partition size, the answer is NO in step 112, and the flow proceeds to step 113. If the current free area size is greater than or equal to this partition size, the answer is YES in step 112, and the flow proceeds to step 114.

In step 113, the cache partition manager 325 sends an error report through the host interface controller 323. This error report may include, for example, the difference between the current free area size and the total size of the one or more partitions in the storage cache control instruction table 403, that is, may include the insufficient free area size.

In step 114, the cache partition manager 325 performs free area size change processing. More specifically, the above-mentioned certain partition size is subtracted from the free area size.

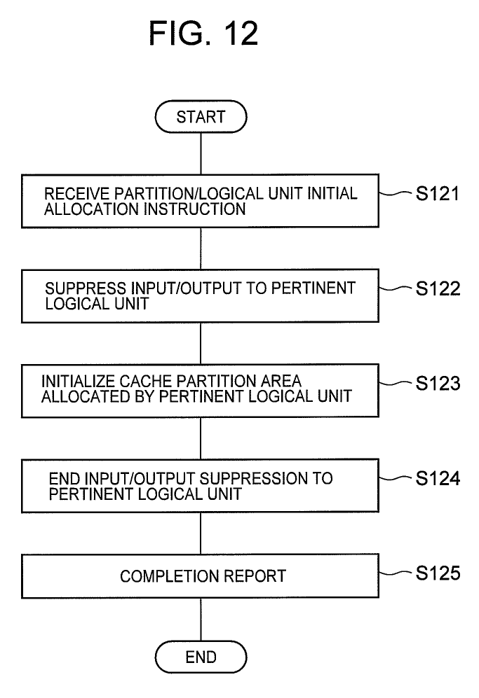

In step 115, the cache partition manager 325 executes a subroutine called partition setting processing (see FIG. 12). For example, the cache partition manager 325 receives a partition/logical unit initial allocation instruction (step 121) and issues a partition/logical unit initial allocation instruction internally (to itself). This instruction designates the LUN, segment size, partition name, and partition size recorded in the storage cache control instruction table 403. Here, the logical unit corresponding to this LUN will be called the “object logical unit.” In response to this instruction, the cache partition manager 325 causes the host interface controller 323 to suppress access (I/O) to the object logical unit (step 122), and initializes the cache partition area allocated to the object logical unit (initializes the management in FIG. 4, for example) (step 123). In this step 123, for example, the LUN, segment size, partition name, and partition size for the object logical unit can be registered in the storage cache disk mapping table 405 (see FIG. 9). After step 123, the cache partition manager 325 instructs the host interface controller 323 to stop suppressing access (step 124) and internally issues a completion report (step 125). This causes the flow to exit the subroutine.

In step 116, the cache partition manager 325 determines whether or not all of the cache partition areas listed in the storage cache control instruction table 403 have been set. If it is determined that not all have been set, the answer is NO in step 116, and step 112 is performed for another cache partition area. When it is determined that all have been set, the answer is YES in step 116, and the flow proceeds to step 117.

In step 117, the cache partition manager 325 sends a completion report through the host interface controller 323.

### System Operation Phase

The DBMS 17 receives a request from the client computer 1 for database operation (such as SQL text), and executes access (I/O) to the database object. If there is a buffer hit in the database buffer corresponding to the database object here, the DBMS 17 ends access to the database object by access to the buffer-hit page, and if there is no buffer hit, an access command designating the LUN corresponding to this database buffer is issued to the storage system 31. The database access controller 111 can calculate the buffer hit ratio for each database buffer by compiling in the storage resource 15 of the host computer 11 whether or not there has been a buffer hit for every access to the database buffer. The buffer hit ratio indicates the number of buffer hits per 100 accesses to a database buffer. The database access controller 111 registers in the buffer hit management table 501 the calculated buffer hit ratio and the number of accesses (number of reads and number of writes) according to the type of access to the database buffer, for every database buffer. As a result, as shown in FIG. 13A, immediately after the end of the database initial setting phase there is no access to any database buffer, so the buffer hit ratio, the number of reads, and the number of writes are all zero (0), but when the system operation phase is entered and an access to a database buffer occurs, the buffer hit ratio, the number of reads, and the number of writes are updated. FIG. 13B shows the buffer hit management table 501 at a certain time T.

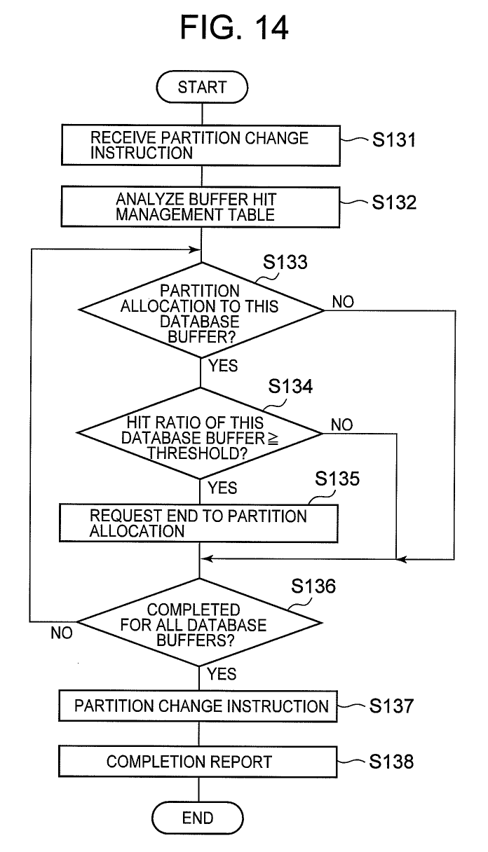

FIG. 14 shows an example of the flow of the processing executed by the DBMS 17 in the system operation phase.

In step 131, the database setting processor 115 receives a partition change instruction. This partition change instruction is either sent from the host computer 11 by a client user, or sent from the storage manager 141 in the managing computer 41 by a human manager. When a partition change instruction is received the flow proceeds to step 132.

In step 132, the database setting processor 115 analyzes the buffer hit management table 501. Steps 133 to 135 are then executed for the database buffer corresponding to a certain column of the buffer hit management table 501 (hereinafter referred to as the pertinent database buffer).

In step 133, the database setting processor 115 determines whether or not a cache partition area has been allocated to the pertinent database buffer (hereinafter referred to as partition allocation). This can be executed by a variety of methods. For instance, whether or not partition allocation has occurred may be determined by asking the storage system 31 if there is a partition name that is the same as the name of the pertinent database buffer, and analyzing the response to this question. As another method, for example, the storage cache control instruction table 403 (see FIG. 8B) sent to the storage system 31 may be compiled in the storage resource 15 of the host computer 11, and whether or not partition allocation has occurred may be determined by referring to this table 403. As yet another method, whether or not partition allocation has occurred may be determined by preparing a column for a flag indicating whether or not partition allocation has occurred in the database buffer disk mapping table 401, and referring to this mapping table 401 when the database setting processor 115 is configured to set this flag upon receipt of a completion report in step 107 of FIG. 10, for example. If it is determined that partition allocation has occurred, the answer is YES in step 133 and the flow proceeds to step 134, but if it is determined that partition allocation has not occurred, the answer is NO in step 133 and the flow proceeds to step 136.

In step 134, the database setting processor 115 determines whether or not the buffer hit ratio of the pertinent database buffer (the buffer hit ratio recorded to the buffer hit management table 501) is at or above a specific threshold (such as 100). If the ratio is determined to be at or above the specific threshold, the answer is YES in step 134 and the flow proceeds to step 135, but if the ratio is determined to be below the specific threshold, the answer is NO in step 134 and the flow proceeds to step 136.

In step 135, the database setting processor 115 produces a request to stop allocation of a cache partition area to the pertinent database buffer (hereinafter referred to as a partition allocation stop request), and stores the produced partition allocation stop request in the storage resource 15.

In step 136, it is determines whether or not processing from step 133 on has been completed for all the database buffers recorded to the buffer hit management table 501. If it is determined that not all processing has been completed, the answer is NO in step 136, and steps 133 onward are performed using as the pertinent database buffer the database buffer corresponding to another column in the table 501. If it is determined that all processing has been completed, the answer is YES in step 136 and the flow proceeds to step 137.

In step 137, the database setting processor 115 prepares a partition change instruction including one or more partition allocation stop requests stored in the storage resource 15, and calls the storage cache adjustment processor 117 to send this partition change instruction to the storage system 31.

In step 138, the database setting processor 115 receives a completion report from the storage system 31 and through the storage cache adjustment processor 117. If it is an error report that is received rather than a completion report, the sender of the partition change instruction received in step 131 may be notified of a partition change failure.

The above is an example of the flow of processing performed by the DBMS 17. This flow begins at the issuance of an instruction from the host computer 11 or the managing computer 41, but instead of this, the DBMS 17 may at regular or irregular intervals refer to the buffer hit management table 501 and check whether there is a database buffer whose buffer hit ratio has exceeded a specific threshold, or steps 135 and 137 may be executed for all database buffers that have exceeded a specific threshold.

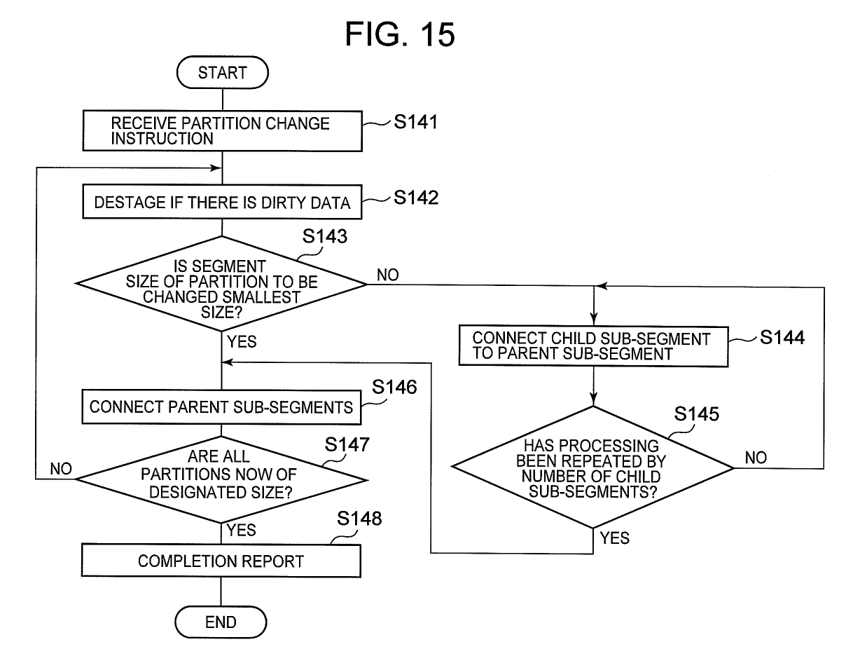

FIG. 15 shows an example of the flow of the processing performed in the storage system 31 that has received a partition change instruction.

In step 141, the cache partition manager 325 receives a partition change instruction through the host interface controller 323. When a partition change instruction is received, the processing of steps 142 onward is performed for the one or more partition allocation stop requests in this partition change instruction (hereinafter referred to as “pertinent stop request”).

In step 142, if there is dirty data in the cache partition area corresponding to the pertinent stop request, the cache partition manager 325 destages this dirty data (that is, writes the dirty data to the disk device 37 that constitutes the logical unit corresponding to the cache partition area).

In step 143, the cache partition manager 325 checks whether or not the segment size of the cache partition area to be changed is the smallest size (sub-segment size). The “cache partition area to be changed” here is, for example, an area not associated any database buffer (hereinafter referred to as a shared cache area). That is, the flow shown in FIG. 15 is a flow employed in an example in which this cache partition area is included in a shared cache area, rather than merely releasing a cache partition area. If the segment size of the partition to be changed is not the smallest size, the answer is NO in step 143 and the flow proceeds to step 144, but if it is the smallest size, the answer is YES in step 143 and the flow proceeds to step 146.

In step 144, the cache partition manager 325 reorganizes the queue management of the parent sub-segment management blocks 80 and the child sub-segment management blocks 90 so that the child sub-segments are connected to the parent sub-segment. This reorganization processing is repeated by the number of child sub-segments (step 145), which allows the segment size of a block moved from the current partition to the changed cache partition area, to match the segment size of the changed cache partition area.

In step 146, the cache partition manager 325 reorganizes the queue management of the parent sub-segment management blocks 80 so that the parent sub-segment management blocks are connected to each other.

In step 147, the cache partition manager 325 determines whether or not the processing from step 142 onward has been performed for all of the partition allocation stop requests in the partition change instruction received in step 141. If not all has been performed, the answer is NO in step 147, and step 142 is executed using another partition allocation stop request as the pertinent stop request, but if all has been performed, the answer is YES in step 147 and the flow proceeds to step 148.

In step 148, the cache partition manager 325 sends a completion report to the DBMS 17 through the host interface controller 323.

With the first embodiment described above, in the database initial setting phase, the DBMS 17 causes the storage system 31 to produce a cache partition area of the same segment size as the page size of the produced database buffer, as a cache partition area corresponding to that database buffer. Here, the buffer size and the partition size are also matched. When the system operation phase is entered, access to the database buffer or the cache partition area associated therewith occurs, but since the page size and segment size match, and the buffer size and partition size also match, there is less decrease in the efficiency with which the cache partition area is utilized.

Also, with the first embodiment described above, a cache partition area corresponding to a database buffer whose buffer hit ratio is at or above a specific threshold (such as 100) is deleted. The deleted cache partition area is allocated to the above-mentioned shared cache area, for example. This affords an increase in the buffer hit ratio in the shared cache area. This deletion of the cache partition area may involve deleting (releasing) all of the cache partition area, or just deleting a part thereof (that is, the area may just be reduced). The reduction ratio, in other words, may be determined by the database setting processor 115 by a specific method. For instance, the reduction ratio may be the quotient of dividing the buffer hit ratio by 100.

### Second Embodiment

A second embodiment of the present invention will now be described. The description here will focus on the differences from the first embodiment, and description of points in common with the first embodiment will be either omitted or simplified.

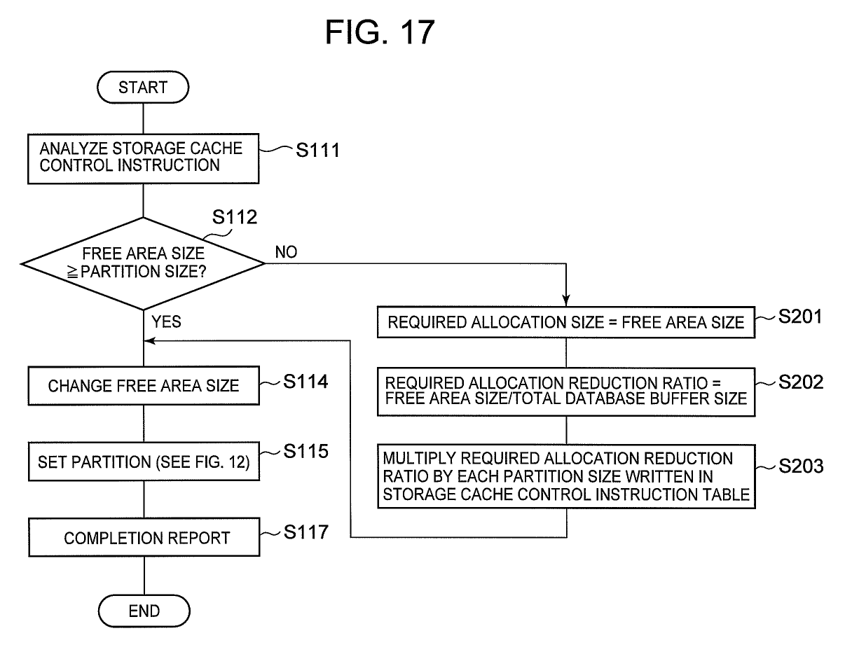

FIG. 17 shows an example of the flow of the processing executed in the storage system 31 that has received a cache group initial allocation instruction in a second embodiment. Portions that are the same as those in the first embodiment are numbered the same.

In this second embodiment, when the answer is NO in step 112, the following steps 201 to 203 are executed instead of sending an error report.

In step 201, the cache partition manager 325 stores a free area size as an allocation request size in the memory 35. In other words, the total database buffer size may be reduced to the current free area size.

In step 202, the cache partition manager 325 stores in the memory 35 the quotient of dividing the free area size by the total database buffer size, as the allocation request reduction ratio.

In step 203, the cache partition manager 325 multiplies the allocation request reduction ratio calculated and stored in step 202 by the various partition sizes written in the storage cache control instruction table 403.

After this, steps 114 and beyond are performed. As a result, the partition size of each cache partition area set in the storage cache 311 becomes a size that is the product of reducing the database buffer size by the above-mentioned allocation request reduction ratio.

The above is a description of the second embodiment. In the above description, all of the cache partition areas are uniformly reduced, but the reduction ratios (allocation request reduction ratios) of the various cache partition areas may instead be different, on the basis of specific information such as the attributes of database objects.

With this second embodiment, if the free area size in the storage cache 311 does not reach the requested partition size (total database buffer size), the requested partition size is reduced to or below the free area size in the setting of each cache partition area, and an error report is not changed by the DBMS 17. As a result, the DBMS 17 does not have to respond to the error report.

Depending on the user or manager, the needs of the user or manager may vary considerably, such as not needing a cache partition area if a cache partition area is not prepared in each partition size corresponding to each database buffer size, so in this second embodiment the DBMS 17 may be told by the user or manager whether an error report is necessary or not. The DBMS 17 may send information indicating whether or not an error report is necessary (hereinafter referred to as error report necessity information) included in a cache group initial allocation instruction. In this case, the cache partition manager 325 analyzes the cache group initial allocation instruction, and if the error report necessity information indicates that an error report is necessary, step 113 in FIG. 11 is executed (that is, an error report is sent) if the answer is NO in step 112, and if the error report necessity information indicates that an error report is not necessary, step 201 in FIG. 17 and beyond may be executed if the answer is NO in step 112.

### Third Embodiment

In this third embodiment, rather than just releasing a cache partition area allocated to a database buffer whose buffer hit ratio is at or above a specific threshold, all or part of a released cache partition area is added to a cache partition area allocated to a database buffer whose buffer hit ratio is below a specific threshold (hereinafter referred to as a partition area to be expanded), resulting in a cache partition area that is larger in size. This improves the cache hit ratio for a cache partition area allocated to a database buffer whose buffer hit ratio is below a specific threshold. This will be described in specific terms below. Here, a database buffer whose buffer hit ratio is at or above a specific threshold will be called a “partition area to be deleted,” and a cache partition area allocated to a database buffer whose buffer hit ratio is below a specific threshold will be called a “partition area to be expanded.”

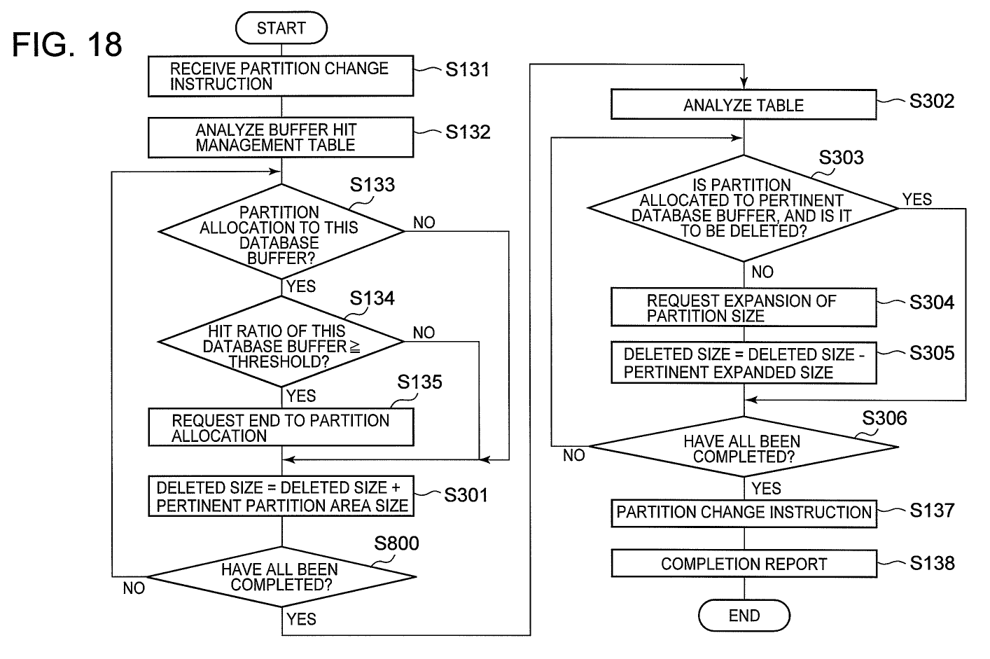

FIG. 18 shows an example of the flow of the processing executed by the DBMS 17 in the system operation phase of the third embodiment.

After partition allocation stop requests have been produced for all of the partition areas to be deleted, partition size expansion requests are produced for all of the partition areas to be expanded, and a partition change instruction including the produced partition allocation stop requests and partition size expansion requests is sent from the DBMS 17 to the storage system 31.

Specifically, step 301 is performed after step 135.

In step 301, the database setting processor 115 stores in the storage resource 15 the sum of adding the partition size of the pertinent partition area size (the partition area to be deleted designated by the partition allocation stop request produced in step 135) to the current deletion size (if the first time, zero (0)). This step 301 is executed for all the database buffers whose buffer hit ratio is at or above a specific threshold.

When step 301 has been executed for all the database buffers whose buffer hit ratio is at or above a specific threshold, the answer is YES in step 800 and the flow proceeds to step 302.

In step 302, the database setting processor 115 analyzes the database buffer disk mapping table 401 and the buffer hit management table 501, and obtains the information necessary for making the determination in step 303 discussed below.

In step 303, the database setting processor 115 determines whether or not a cache partition area has been allocated to the pertinent database buffer (a certain database buffer whose buffer hit ratio is below a specific threshold), and this cache partition area is to be deleted. If the result of this determination is positive, the answer is YES in step 303 and the flow proceeds to step 306, but if the result is negative, the answer is NO in step 303 and the flow proceeds to step 304.

In step 304, the database setting processor 115 produces a partition size expansion request and stores it in the storage resource 15. This partition size expansion request includes, for example, the partition name of the partition area to be expanded, and the expansion size. The partition area to be expanded here is, for example, a cache partition area allocated to a database buffer selected from among one or more database buffers whose buffer hit ratio is below a specific threshold. The expansion size is the partition size added to this cache partition area. The expansion size is determined by the database setting processor 115 on the basis of preset rules.

In step 305, the database setting processor 115 stores in the storage resource 15 the remainder of subtracting the above-mentioned expansion size from the deletion size at the current point (in the first step 305, the total of the partition sizes of all the partition areas to be deleted), which serves as the deletion size.

In step 306, the database setting processor 115 determines whether or not step 303 and subsequent processing has been performed for all the databases. If it has been performed, the answer is YES in step 306 and the flow proceeds to step 137, but if it has not been performed, the answer is NO in step 306 and step 303 is executed for any unprocessed database buffers.

In step 307, the database setting processor 115 prepares a partition change instruction and calls the storage cache adjustment processor 117 to send the partition change instruction to the storage system 31. This partition change instruction includes all of the partition sizes and all of the partition allocation stop requests stored in the storage resource 15.

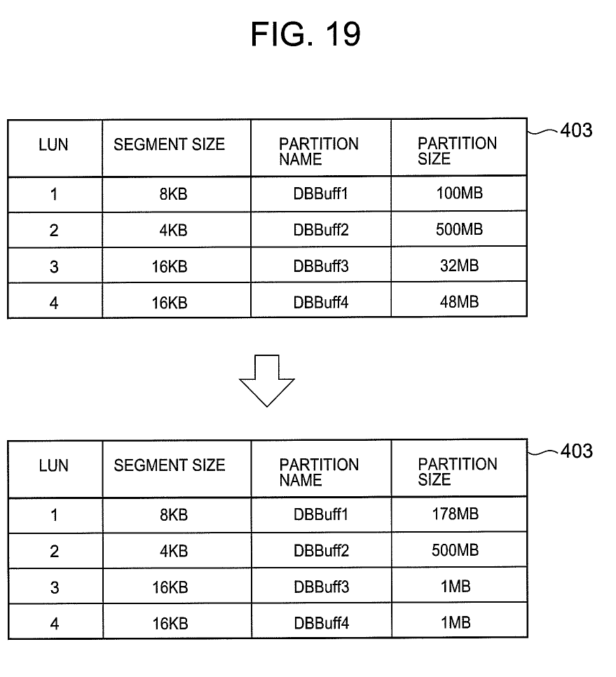

The above is a description of the processing executed by the DBMS 17 in the system operation phase in the third embodiment. Instead of producing the partition allocation stop requests and partition size expansion requests separately, a request may be produced that designates which partition area to be deleted will be added to which partition area to be expanded. More specifically, as shown in FIG. 19, for example, the upper storage cache control instruction table 403 may be sent in the database initial setting phase, and the lower storage cache control instruction table 403 may be sent along with a partition change instruction in the system operation phase. In this example, the DBMS 17 instructs the storage system 31 to add 31 MB (megabytes) of the 32 MB of partition size of the partition area to be deleted DBBuff3 (in FIG. 13, the cache partition area associated with the database buffer DBBuff3 with a buffer hit ratio of 100), and 47 MB of the 48 MB of partition size of the partition area to be deleted DBBuff4 (in FIG. 13, the cache partition area associated with the database buffer DBBuff4 with a buffer hit ratio of 100) (for a total of 78 MB) to the 100 MB partition size of the partition area to be expanded DBBuff1, and thereby expand the partition size of the partition area to be expanded DBBuff1 to 178 MB.

With the storage system 31, the cache partition manager 325 receives this partition change instruction and performs the processing of steps 142 and beyond as described through reference to FIG. 15. With this processing, in step 142, for example, processing that reserves a block equal to the expansion size can be executed for the partition area to be expanded. Also, processing according to the various partition size expansion requests may be executed after processing according to all of the partition allocation stop requests, or partition size expansion requests may be processed in parallel with the deletion of partition areas to be deleted. To put this another way, the expansion size the area not allocated to any database buffer (the shared cache area) may be added to the partition area to be expanded after the partition area to be deleted has been added to the shared cache area, or the expansion size of the partition area to be deleted (if not enough, then including all or part of another partition area to be deleted) may be added to the partition area to be expanded directly, without being added to the shared cache area. The result of this is that the partition area to be changed is the partition area to be deleted or the shared cache area, and the changed partition area is the shared cache area or partition area to be expanded.

When the partition area to be changed is added to the changed partition area, the segment size of the partition area to be changed is sometimes different from the segment size of the changed partition area. In this case, segment change processing, in which the segment size of the partition area to be changed is changed to the segment size of the changed partition area, can be executed at a specific timing (such as between steps 142 and 143). In this segment change processing, the segment size of the partition area to be changed can be matched to the segment size of the changed partition area by increasing or decreasing the number of sub-segments that make up each segment in the partition area to be changed on the basis of the segment size after change. More specifically, the technique disclosed in Japanese Laid-Open Patent Application No. 2006-227688 may be applied, for example.

The above series of processing allows the partition area to be deleted to be added to the partition area to be expanded in the system operation phase. This affords an increase in the cache hit ratio in the partition area to be expanded.

There are various ways in which the DBMS 17 can allocate an area of the deletion size (the total of the deletions of one or more partition areas to be deleted) to one or more partition areas to be expanded. For instance, an area of the deletion size may be allocated to just one partition area to be expanded (such as a partition area corresponding to the database buffer with the lowest buffer hit ratio), or an area of the deletion size may be allocated to a plurality of partition areas to be expanded in a ratio according to the various buffer hit ratios. The “ratio according to the various buffer hit ratios” may be a ratio based on the inverse ratio of the buffer hit ratio, for example. More specifically, for example, if the buffer hit ratio corresponding to a first partition area to be expanded is 80, and the buffer hit ratio corresponding to a second partition area to be expanded is 40, the ratio of these buffer hit ratios is 2:1, so the inverse ratio would be 1:2. If the deletion size is 90, then 90×⅓=30 is allocated to the first partition area to be expanded, and 90×⅔=60 is allocated to the second partition area to be expanded. Doing this means that more area will be allocated to partition areas to be expanded corresponding to database buffers with a low buffer hit ratio than to partition areas to be expanded corresponding to database buffers with a high buffer hit ratio, so there is less decrease in the buffer hit ratio.

### Fourth Embodiment

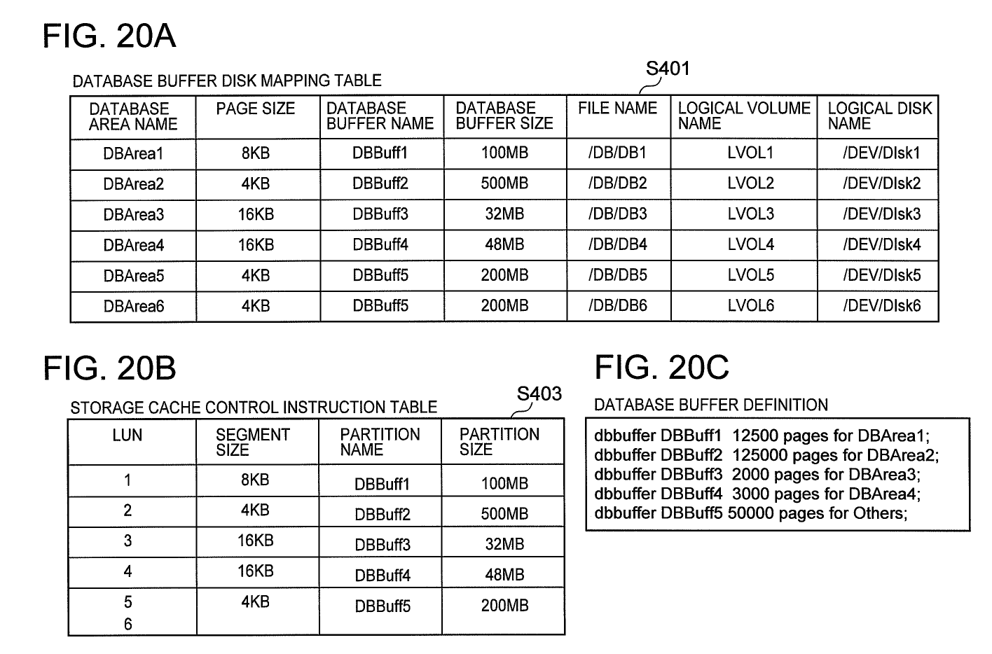

In this fourth embodiment, a single database buffer is associated with a plurality of database areas and a plurality of logical units corresponding to these database areas. In this case, the database buffer disk mapping table 401 is the table shown in FIG. 20A, for example, and the storage cache control instruction table 403 is the table shown in FIG. 20B, for example. In FIGS. 20A and 20B, the single database buffer mentioned above is the database buffer DBBuff5.

This can be defined by the database buffer definition shown in FIG. 20C, for example. Specifically, this can be defined by listing a character string (such as “others”) signifying the designation of a database area that is not clearly designated, rather than listing the names of the database areas in the database buffer DBBuff5. When this character string is detected, the database setting processor 115 can associate the names of all database areas that are described in the database area definition but are not described in the database buffer definition, with the database buffer corresponding to that character string.

A single logical unit is allocated to a single cache partition area (in other words, a plurality of cache partition areas are exclusively allocated respectively to a plurality of logical units), but in this fourth embodiment, a plurality of logical units are allocated to the cache partition areas associated a plurality of database areas.

Several embodiments of the present invention were described above, but these are just examples used to describe the present invention, and the scope of the present invention should not be construed to be limited to these embodiments alone. The present invention can be worked in various other modes. For instance, the various instructions received by the storage system 31 from the DBMS 17, either through or not through the storage manager 141, may first be stored in a dedicated storage area (such as a logical unit or memory area) provided to the storage resource in the storage system 31, and then acquired from this dedicated storage area and analyzed. Also, for example, the host computer 11 may be installed in the storage system 31 as a so-called blade server.

What is claimed is:

1. A database management system operated by a host computer connected to a storage system that executes, in response to a partition setting instruction from an external device, allocation of each of a plurality of cache partition areas obtained by logically partitioning a cache memory, to each of a plurality of storage devices, said database management system comprising:
a setting processor that determines a size related to each cache partition area associated with each database buffer on the basis of a size related to each database buffer, and produces a partition setting instruction to perform setting related to each of the cache partition areas at the determined size; and
an instruction sending unit that sends the produced partition setting instruction.

2. The database management system according to claim 1,
wherein the size related to each database buffer is a size of a page, which is a storage area that makes up a database buffer and is an access unit, for each of the database buffers,
the size related to each cache partition area is a size of a segment, which is a storage area that makes up a cache partition area and is an access unit, for each of the cache partition areas, and
the setting processor determines the segment size of each of the cache partition areas to be the same as the page size of each database buffer associated with each of the cache partition areas.

3. The database management system according to claim 2,
wherein the size related to each database buffer is further a buffer size, which is the size of the database buffer itself, for each of the database buffers, the size related to each cache partition area is further a partition size, which is the size of the cache partition area itself, for each of the cache partition areas, and
the setting processor determines, during initial setting, the partition size of each of the cache partition areas to be the same as the buffer size of each database buffer associated with each of the cache partition areas.

4. The database management system according to claim 3,
wherein the storage system is constituted so as to, when the partition setting instruction is received and if a free area size in the cache memory is smaller than the total size of a plurality of partitions designated by the partition setting instruction, send back an error report to a sender of the partition setting instruction,
upon receipt of the error report, the setting processor newly produces a partition setting instruction in which the number and/or the size of cache partition areas is adjusted so that the total size of the plurality of partitions does not exceed the free area size, and
the instruction sending unit sends the newly produced partition setting instruction.

5. The database management system according to claim 4,
wherein the setting processor adjusts the total size of the plurality of partitions so as not to exceed the free area size by reducing each of the plurality of partitions by the same reduction ratio.

6. The database management system according to claim 3,
wherein the storage system is constituted so as to, when the partition setting instruction is received and if a free area size in the cache memory is smaller than the total size of a plurality of partitions designated by the partition setting instruction, send back an error report to a sender of the partition setting instruction, and
the setting processor is received by a user whether or not an error report is necessary, and includes error necessity information indicating whether or not an error report is necessary in the partition setting instruction.

7. The database management system according to claim 1,
wherein the plurality of database buffers are respectively associated with a plurality of database areas managed by the database management system, the database management system further comprises an access controller for executing access to each of the database areas, and when the access controller executes access to a certain database area, if there is a buffer hit in a corresponding database buffer, which is a database buffer corresponding to this certain database area, the access controller accesses the area reserved by the buffer hit, and if there is no buffer hit,^{[1]} an access command designating a storage device allocated to a cache partition area associated with the corresponding database buffer is sent from the host computer to the storage system, and the storage system temporarily holds data according to this access command in the cache partition area to which the storage device designated by the access command has been allocated,
the access controller calculates for each database buffer a buffer hit ratio indicating the number of buffer hits out of the number of times the database buffer has been accessed, and
the setting processor produces an instruction signifying a setting change of the size related to at least one of the plurality of cache partition areas, as the partition setting instruction, on the basis of the buffer hit ratio calculated for each database buffer.

8. The database management system according to claim 7,
wherein the setting processor produces an instruction including a delete meaning, which means to delete from the cache memory all or part of the cache partition area associated with a database buffer whose buffer hit ratio is at or above a specific threshold, as the partition setting instruction.

9. The database management system according to claim 8,
wherein the setting processor produces an instruction including an add meaning, which means to add an area equivalent to the size of the deleted area to another cache partition area out of the plurality of cache partition areas, as the partition setting instruction.

10. The database management system according to claim 9,
wherein the setting processor designates, in the partition setting instruction, the cache partition area associated with the database buffer with the lowest buffer hit ratio, as the other cache partition area.

11. The database management system according to claim 9,
wherein each of the two or more cache partition areas associated with two or more database buffers whose buffer hit ratio is under a specific threshold is the other cache partition area, and
the setting processor determines an allocation proportion corresponding to each of the two or more cache partition areas on the basis of the buffer hit ratio of each of the two or more database buffers, and includes as the add meaning a meaning of adding an area equivalent to the determined allocation proportion out of the area equivalent to the size of the deleted area, to each of the other cache partition areas.

12. The database management system according to claim 11,
wherein the setting processor sets the allocation proportion of the cache partition area associated with a database buffer with a low buffer hit ratio to be higher than the allocation proportion of the cache partition area associated with a database buffer with a high buffer hit ratio.

13. A computer system comprising a storage system and a host computer,
wherein the storage system has a plurality of storage devices, a cache memory, and a controller, and the controller is constituted such that when a plurality of cache partition areas obtained by logically partitioning the cache memory have been prepared, if an access command designating a certain storage device out of the plurality of storage devices is received from the host computer, the controller temporarily stores data to be accessed by this access command in the cache partition area to which the certain storage device has been allocated out of the plurality of cache partition areas,
the host computer has a database management system,
the database management system comprises:
a setting processor that determines a size related to each cache partition area associated with each database buffer on the basis of a size related to each database buffer, and produces a partition setting instruction to perform setting related to each of the cache partition areas at the determined size; and
an instruction sending unit that sends the produced partition setting instruction, and
the controller of the storage system receives the partition setting instruction sent from the instruction sending unit, prepares a plurality of cache partition areas by logically partitioning the cache memory according this partition setting instruction, and allocates any of the plurality of storage devices to each of the plurality of cache partition areas.

14. The computer system according to claim 13, wherein the size related to each database buffer is both the size of a page, which is a storage area that makes up a database buffer and is an access unit, and the buffer size, which is the size of a database buffer itself, for each of the database buffers,
the size related to each cache partition area is both the size of a segment, which is a storage area that makes up a cache partition area and is an access unit, and the partition size, which is the size of a cache partition area itself, for each of the cache partition areas, and
the setting processor determines the segment size of each of the cache partition areas to be the same as the page size of each database buffer associated with each of the cache partition areas, and determines, during initial setting, the partition size of each of the cache partition areas to be the same as the buffer size of each database buffer associated with each of the cache partition areas.

15. The computer system according to claim 14,
wherein when the controller of the storage system receives the partition setting instruction, if a free area size in the cache memory is smaller than the total size of a plurality of partitions designated by the partition setting instruction, the controller of the storage system adjusts the number and/or the size of cache partition areas so that the total size of the plurality of partitions does not exceed the free area size, and prepares two or more cache partition areas in the adjusted number and/or size.

16. The computer system according to claim 14,
wherein the plurality of database buffers are respectively associated with a plurality of database areas managed by the database management system, the database management system further comprises an access controller for executing access to each of the database areas, and when the access controller executes access to a certain database area, if there is a buffer hit in a corresponding database buffer, which is a database buffer corresponding to this certain database area, the access controller accesses the area reserved by the buffer hit, and if there is no buffer hit,^{[1]} an access command designating a storage device allocated to a cache partition area associated with the corresponding database buffer is sent from the host computer to the storage system, and the storage system temporarily holds data according to this access command in the cache partition area to which the storage device designated by the access command has been allocated, and in the area thereof reserved by a cache hit,
the access controller calculates for each database buffer a buffer hit ratio indicating the number of buffer hits out of the number of times the database buffer has been accessed,
the setting processor produces an instruction signifying a setting change of the size related to at least one of the plurality of cache partition areas, as the partition setting instruction, on the basis of the buffer hit ratio calculated for each database buffer, and
the controller of the storage system performs a setting change of the size related at least one of the plurality of cache partition areas, according to the partition setting instruction.

17. The computer system according to claim 16, wherein the controller of the storage system deletes from the cache memory all or part of a cache partition area associated with a database buffer whose buffer hit ratio is at or above a specific threshold, as the setting change.

18. The computer system according to claim 17, wherein the controller of the storage system adds an area equivalent to the deleted area size to another cache partition area out of the plurality of cache partition areas, as the setting change.

19. A cache logical partitioning method,
wherein a database management system determines a size related to each cache partition area associated with each database buffer on the basis of a size related to each database buffer,
the database management system produces a partition setting instruction to perform setting related to each of the cache partition areas in the determined size,
the database management system sends the produced partition setting instruction, and
a storage system receives the partition setting instruction, prepares a plurality of cache partition areas by logically partitioning the cache memory according to the partition setting instruction, and allocates any of a plurality of storage devices each of the plurality of cache partition areas.
